(19) United States
(12) Patent Application Publication
(10) Pub. No.: US 2025/0345770 A1
(43) Pub. Date: Nov. 13, 2025

(54) CHEMICAL FLOW-REACTOR

(71) Applicant: JOHNSON MATTHEY PUBLIC LIMITED COMPANY, London (GB)

(72) Inventors: Todd ROMESBERG, Savannah, GA (US); William WHITTENBERGER, Savannah, GA (US)

(21) Appl. No.: 18/854,380

(22) PCT Filed: May 4, 2023
(86) PCT No.: PCT/US2023/021000

§ 371 Date: Oct. 4, 2024

Related U.S. Application Data
(60) Provisional application No. 63/364,161, filed on May 4, 2022.

(51) Int. Cl. B01J 19/24; B01D 53/88; B01J 19/00

(52) U.S. Cl. CPC B01J 19/249; B01J 19/0013; B01D 53/885; B01J 2219/00081; B01J 2219/2454; B01J 2219/2459; B01J 2219/2462; B01J 2219/2479; B01J 2219/2491

(57) ABSTRACT

A chemical flow reactor comprising: a housing having an inlet and an outlet; at least one heat exchange pipe extending through the interior of the housing; a space defined between the interior surface of the housing and the outer surface of Gas Flow the at least one pipe, said space being in fluid communication with the inlet and the outlet; and a plurality of plates stacked within said space forming a stacked plate assembly between the inlet and the outlet, each plate comprising at least one hole through which the at least one pipe extends such that the at least one pipe extends through the stacked plate assembly. An active chemical, such as a catalyst, is disposed on each plate.

### FIELD

The present specification relates to chemical flow-reactors such as catalytic flow-reactors.

### BACKGROUND

Various designs for chemical flow-reactors, such as catalytic flow-reactors, are known in the art. Certain flow-reactors are designed to provide heat exchange fluid for heating or cooling a process fluid before, during, or after reaction. In such cases, the reactor may have a housing with one or more pipes extending therethrough. Heat exchange fluid may be flowed through the one or more pipes with process fluid flowing through the reactor housing around the one or more pipes. In an alternative approach, process fluid may be flowed through the one or more pipes and heat exchange fluid provided within the reactor housing around the one or more pipes. In either case, thermal energy is exchanged between the heat exchange fluid and the process fluid at the pipe walls. The heat exchange fluid and the process fluid may be liquid or gaseous.

It is also known to provide one or more active chemicals within such flow-reactor designs. For example, a catalyst may be provided within the flow-reactor to drive the desired chemical reaction within the process fluid. The catalyst may be provided in a pelletized form such that process gas flows through the pelletized catalyst to drive the chemical reaction. In a reactor configuration in which heat exchange fluid is flowed through one or more pipes with process fluid flowing through the reactor housing around the one or more pipes, the pelletized catalyst can be provided within the reactor housing around the pipes. In a reactor configuration in which process fluid is flowed through the one or more pipes and heat exchange fluid provided within the reactor housing around the one or more pipes, the pelletized catalyst can be provided within the one or more pipes.

Several factors affect the technical and commercial efficiency of such flow-reactors including:
contact surface area between the process fluid and the active chemical/catalyst in the flow-reactor;
contact time between the process fluid and the active chemical/catalyst in the flow-reactor; efficacy of the active chemical in the flow-reactor;
process fluid flow rate and pressure drop through the reactor as the process fluid flows through/over the active chemical/catalyst;
efficiency of heat exchange between the process fluid and the heat exchange fluid to optimize temperature control within the flow-reactor (including achieving a target temperature range/value for the process fluid and/or uniformity of temperature control for the process fluid flowing through the reactor);
stability/uniformity of performance and/or lifetime of the flow-reactor configuration (e.g., in terms of maintaining an optimized combination of the aforementioned functional parameters over an extend lifetime of operation);
cost of constructing the flow-reactor and/or ease of maintenance of the flow-reactor (e.g., to introduce/replace the active chemical/catalyst in the reactor); and cost of operating the flow reactor.

It is an aim of the present specification to provide a chemical flow-reactor configuration which provides an improved combination of at least some of these parameters, at least for certain applications.

### SUMMARY OF INVENTION

The present specification provides a chemical flow reactor (e.g. a catalytic flow reactor) comprising:
a housing (shell) having an inlet and an outlet;
at least one pipe (a heat exchange pipe) extending through the interior of the housing;
a space defined between the interior surface of the housing and the outer surface of the at least one pipe, said space being in fluid communication with the inlet and the outlet;
a plurality of plates stacked within said space forming a stacked plate assembly between the inlet and the outlet, each plate comprising at least one hole through which the at least one pipe extends such that the at least one pipe extends through the stacked plate assembly with each plate extending between the outer surface of the at least one pipe and the inner surface of the housing and forming a plate-pipe interface region adjacent the outer surface of the at least one pipe and a plate-housing interface region adjacent the inner surface of the housing;
an active chemical (e.g., comprising or consisting of at least one catalyst and/or adsorbent) disposed on at least a portion of at least one surface of each plate (e.g., coated or adhered to the plate),
wherein at least some of the plates within the stacked plate assembly are non-planar (e.g., corrugated), each non-planar plate comprising a series of grooves and ridges,
wherein adjacent plates within the stacked plate assembly are configured such that the grooves form fluid flow channels between the adjacent plates, and
wherein the plurality of plates within the stacked plate assembly comprise a first set of plates which form an interference fit with the at least one pipe restricting fluid flow through the plate-pipe interface region, and a second set of plates which form a clearance fit with the at least one pipe enabling fluid flow through the plate-pipe interface region, the first and second set of plates alternate within the stacked plate assembly thereby directing fluid in a circuitous path through the fluid flow channels between the plates from the inlet to the outlet.

In the context of the present specification, an interference fit provides a close fit between components so as to inhibit process fluid flow through the interference fit. In contrast, a clearance fit provides an opening or clearance between components so that process fluid can readily flow through the clearance fit.

The present specification thus provides a chemical flow-reactor, for example a catalytic flow-reactor, having one or more heat exchange pipes extending through the reactor. Configurations according to this specification periodically permit process gas to conduct heat from heating pipes as the process gas flows past these pipes. This heating allows the process gas to gain necessary thermal energy for chemical reaction before passing a section of a coated plate. The non-planar coated plates increase the contact area between the coated plate surfaces and process gas. This enhanced contact results in increased chemical activity that improves process efficiency and throughput. The configuration provides a replacement for pellet configurations with increased heat transfer, decreased pressure drop, and increased surface area. The configuration has stable and controllable operating parameters to sustain efficient operation over extended time periods. Other advantages of configurations according to the present specification include ease of construction and replacement of the plates. The configurations are also useful when requiring the use of catalyst materials which are not readily formed into durable pellets, opening the possibility to use different active chemicals/catalysts.

Adjacent plates within the stacked plate assembly may be in contact with each other and have a non-complimentary shape when configured in the stacked arrangement which ensures that flow channels between the adjacent plates are held open by the shape of the plates themselves, without the requirement for separate spacer structures. This construction simplifies the reactor configuration, enables easy loading and replacement of plates, and allows a large number of plates to be stacked together in a simple process.

The non-planar plates within the stacked plate assembly can be provided as separate plate components which are not physically attached to each other. In this case, the stacked plate assembly is formed by placing the non-planar plates on top of each other. Alternatively, at least a number of the non-planar plates within the stacked plate assembly can be physically attached to each other. For example, at least a number of the non-planar plates may be 3D printed to form a monolithic three-dimensional structure comprising the non-planar plates. A number of such monolithic structures can be provided and stacked to form the stacked plate assembly (e.g., where each monolithic structure can be separated by a sealing plate as described later). Alternatively, the entire stacked plate assembly may be provided as a monolithic structure formed by 3D printing. Alternatively still, rather than 3D printing a monolithic structure comprising a plurality of the non-planar plates, such a structure can be formed by attaching or bonding a plurality of the non-planar plates together.

The plates may be corrugated with linear or non-linear (e.g., herringbone) channels. The first set of plates can be orientated such that their grooves extend in a first direction and the second set of plates can be orientated such that their grooves extend in a second direction which is rotationally off set from the first direction. As such, the corrugated structure of the plates may be substantially the same, with the plates being rotationally off set to ensure that the plates do not collapse (nest) together in a complimentary manner but rather maintain open flow channels therebetween for process fluid. By rotationally off set, it is meant that the plates are rotationally oriented relative to a central axis of the reactor configuration such that the channels of adjacent plates are oriented in different directions and do not nest together.

In one configuration, the first set of plates form a clearance fit with the housing enabling fluid flow through the plate-housing interface region, and the second set of plates form an interference fit with the housing restricting fluid flow through the plate-housing interface region, whereby the circuitous path for fluid flow is, at least in part, between the clearance fit at the plate-housing interface region of the first set of plates and the clearance fit at the plate-pipe interface region of the second set of plates. This configuration ensures that the process gas flows radially between a heat exchange pipe and the reactor wall and vice versa in alternating fashion up the stacked plate assembly.

According to certain configurations, more than one pipe extends through the stacked plate assembly, each plate comprising a plurality of holes, one hole for each pipe. For example, each plate of the first and second sets of plates may comprise at least one clearance fit hole and at least one interference fit hole. In the stacked plate assembly, the at least one clearance fit hole of the first set of plates is around a different pipe to the at least one clearance fit hole of the of the second set of plates, and the at least one interference fit hole of the first set of plates is around a different pipe to the at least one interference fit hole of the second set of plates. The circuitous path for fluid flow is, at least in part, between the clearance fit at the plate-pipe interface region of the first set of plates around one pipe and the clearance fit at the plate-pipe interface region of the second set of plates around a different pipe.

In certain configurations, each plate of the first and second sets of plates may comprise a plurality of clearance fit holes and a plurality of interference fit holes. In the stacked plate assembly, the clearance fit holes of the first set of plates are around different pipes to the clearance fit holes of the second set of plates, and the interference fit holes of the first set of plates are around different pipes to the interference fit holes of the second set of plates. A plurality of circuitous paths for fluid flow are thus provided between the different pipes.

The stacked plate assembly may also comprise a series of sealing plates (e.g., planar plates) which are periodically placed between the non-planar plates, the sealing plates each comprising a peripheral seal which prevents fluid flow between the housing and the stacked plate assembly. These flat plates with seals prevent process gas from bypassing corrugated plates by flowing through a clearance between the reactor housing/shell and the corrugated plates. Furthermore, the flat plates facilitate the mixing of process fluid passing through various flow channels.

It is also envisaged that the stacked plate assembly may comprise more than two sets of non-planar plates which differ in terms of their non-planar shape, rotational orientation, and/or fit with the at least one pipe or housing.

While an important feature of the present specification is the provision of plate structures in the space between the pipes and the reactor housing/shell, in accordance with certain configurations structured elements can also be provide within one or more of the pipes to enhance heat transfer and/or to promote further reactions within the pipes if coated with a suitable active chemical.

The present specification also provides a method of operating a chemical flow reactor as described above. Process fluid (e.g., process gas) is flowed from the inlet to the outlet through the stacked plate assembly, the process fluid reacting with the active chemical on the plates or reacting due to a catalytic action of the active chemical on the plates. Heat exchange fluid (e.g., at least a portion of which is liquid) is flowed through the one or more pipes. As such, heat is exchanged between the process fluid and the heat exchange fluid at the walls of the one or more pipes.

The process fluid flow and the heat exchange fluid flow can be in a co-current or counter current direction. Furthermore, the heat exchange fluid may be at a higher temperature than the process fluid such that thermal energy is transferred from the heat exchange fluid to the process fluid, or vice versa. In certain configurations, the process fluid is circulated from the outlet back though at least one of the pipes, whereby the process fluid functions, at least in part, as the heat exchange fluid enabling heat transfer between reactant process fluid and product process fluid. It is also envisaged that the reactor housing/shell may be (externally) heated, e.g., via electrical heating or rerouting exhaust gases acting as a heat exchanger.

The present specification also provides a set of chemically coated plates for use in the chemical flow-reactor or the method as described herein. The set of chemically coated plates comprises a plurality of non-planar plates, each non-planar plate comprising a series of grooves and ridges with an active chemical (e.g., at least one catalyst) coated on at least a portion of at least one surface of each non-planar plate. Each non-planar plate comprises one or more holes therethrough for accommodating one or more heat exchange pipes in use. The plurality of non-planar plates comprises a first set of plates having a first configuration of holes in terms of a size, shape, and location of the holes across each plate, and a second set of plates having a second configuration of holes in terms of a size, shape, and location of the holes across each plate, the first and second configurations having corresponding hole locations when the first and second sets of plates are rotationally aligned for accommodating one or more heat exchange pipes in use but different hole sizes or shapes at corresponding locations of the first and second sets of plates.

The plates may be corrugated with linear or non-linear channels. When the holes in the first and second sets of plates are rotationally aligned for accommodating one or more heat exchange pipes in use, the first set of plates are orientated such that their grooves extend in a first direction and the second set of plates are orientated such that their grooves extend in a second direction which is rotationally off set from the first direction.

The set of chemically coated plates may further comprise a set of planar sealing plates. Each planar sealing plate comprises a peripheral seal. The planar sealing plates also comprise one or more holes in corresponding locations to the first and second configurations when the first and second sets of plates and the planar sealing plates are rotationally aligned for accommodating one or more heat exchange pipes in use.

The set of chemically coated plates may be provided as separate plates to be constructed into a stacked plate assembly within a reactor. Alternatively, the set of chemically coated plates can be provided in a pre-configured stacked plate assembly for loading into a reactor.

### BRIEF DESCRIPTION OF THE DRAWINGS

For a better understanding of the present invention and to show how the same may be carried into effect, certain embodiments of the present invention will now be described by way of example only with reference to the accompanying drawings, in which:

FIG. 1 shows a cross-sectional view of an example of a flow reactor with a central heat exchange pipe and a stack of corrugated chemically coated plates;

FIG. 2 shows another example of a flow reactor which has a plurality of heat exchange pipes and a stack of corrugated chemically coated plates;

FIG. 3 shows a portion of the flow reactor of FIG. 2 indicating flow path for process gas;

FIG. 4 shows an example of a planar sealing plate;

FIG. 5 shows an external view of an example of a flow reactor including an inlet, an outlet, and a plurality of heat exchange pipes;

FIG. 6 shows a cross-sectional view of the flow reactor of FIG. 5 indicating section A-A (shown in FIG. 7) and section B-B (shown in FIG. 8);

FIG. 7 shows section A-A from FIG. 6;

FIG. 8 shows section B-B from FIG. 6;

FIG. 9 shows a portion of the flow reactor of FIGS. 5 to 8 indicating flow paths for process gas;

FIG. 10 shows corrugated plate A for use in the reactor of FIGS. 5 to 9;

FIG. 11 shows corrugated plate B for use in the reactor of FIGS. 5 to 9;

FIG. 12 shows a flat plate with sealing ring for use in the reactor of FIGS. 5 to 9; and

FIG. 13 shows a cross-sectional view of the flow reactor of FIGS. 5 to 9 indicating flow paths for process gas.

In the figures corresponding parts are labelled with a common numerical reference number: inlet port 1; exhaust or outlet port 2; heating fluid pipes 3; flat plates 4 with sealing rings; first type of corrugated plates 5; second type of corrugated plates 6; reactor shell or housing 7; and end cap 8.

### DETAILED DESCRIPTION

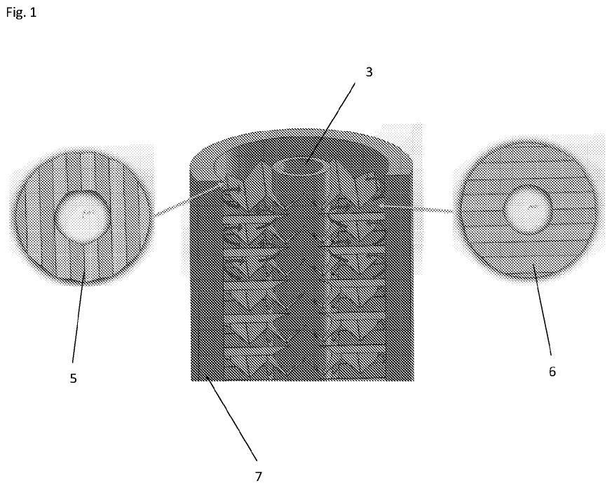

FIG. 1 shows a cross-sectional view of an example of a flow reactor with a central heat exchange pipe 3 and a stack of corrugated chemically coated plates 5, 6. Two different types of alternating plates 5, 6 are provided in the stack. The two different types of plate are rotationally off set such that adjacent plates have corrugations oriented at 900 relative to each other to maintain open flow channels between the plates. That is, the corrugations in the plates cannot nest together which would collapse the open structure of the stack. The structure and orientation of the corrugated plates defines the flow channels without the need to provide separate spacer components.

In addition to the difference in the orientation of the corrugations in alternating plates, the alternating plates also differ in the nature of the fit with the central heat exchange pipe and outer wall or shell of the reactor configuration. The plates alternate between a first plate 5 (left hand side in FIG. 1) which has an interference fit with the heat exchange pipe and a clearance fit with the housing/shell 7 and a second plate 6 (right hand side of FIG. 1) which has a clearance fit with the heat exchange pipe 3 and an interference fit with the reactor housing/shell 7. The alternating plates thus force process fluid to follow a circuitous path as shown by the arrows in the figure. This enables process gas to flow radially over the chemically coated plates while periodically being heated (or alternatively cooled) as the process gas flows adjacent to the heat exchange pipe while passing through the clearance fit of the second plate type.

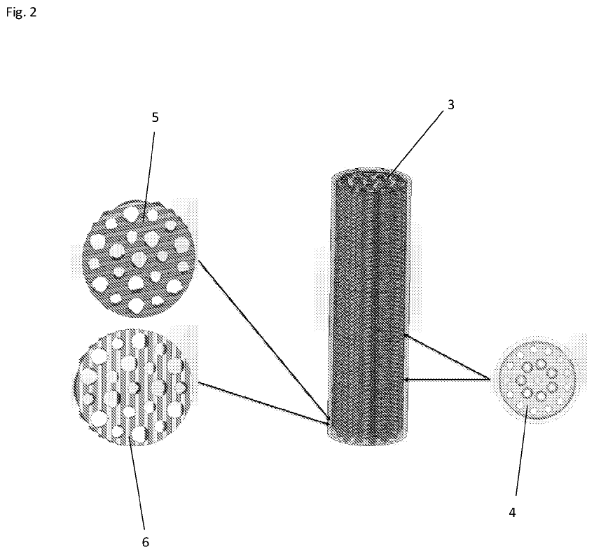

FIG. 2 shows another example of a flow reactor which has a plurality of heat exchange pipes 3 and a stack of corrugated chemically coated plates 5, 6. As with the example shown in FIG. 1, two different types of alternating corrugated plates 5, 6 (left hand side of FIG. 2) are provided in the stack. The two different types of plate have corrugations which are rotationally off set relative to each other to maintain open flow channels between the plates in a similar manner to the example of FIG. 1. The difference here is that a plurality of holes is provided in each of the plates such that the plurality of heat exchange pipes 3 can extend through the stack of plates. The two different types of plates have a hole configuration such that when the plurality of holes are rotationally aligned in the stack with the pipes extending therethrough, the corrugations are rotationally off set. That is, the pipes can function to hold the plates in a rotationally off set orientation in terms of their corrugations. This ensures that the plates cannot nest together, which would collapse the open structure of the stack. Again, the structure and orientation of the corrugated plates defines the flow channels without the need to provide separate spacer components.

The stack of plates also includes planar sealing plates 4 (right hand side of FIG. 2) which are periodically placed in the stack. The sealing plates 4 also comprise a hole configuration which is complimentary to the hole configurations in the corrugated plates to enable the pipes 3 to extend through all of these plates. The sealing plates each comprising a peripheral seal which prevents fluid flow between the housing and the stacked plate assembly. These flat plates with seals prevent process gas from bypassing corrugated plates by flowing through a clearance between the reactor housing/shell and the corrugated plates. Furthermore, the flat plates facilitate the mixing of process fluid passing through various flow channels.

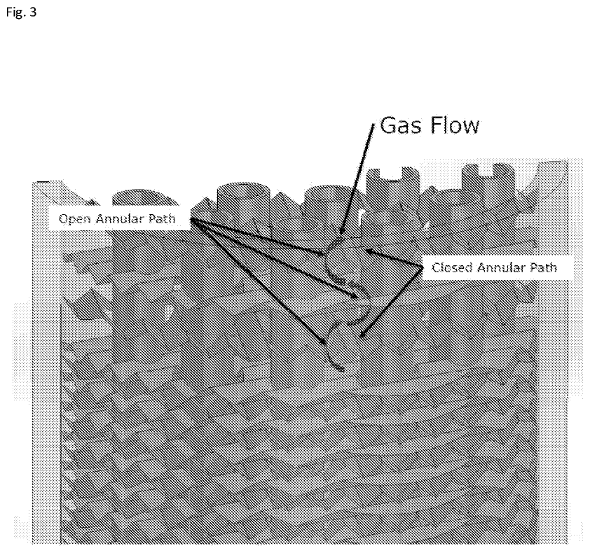

FIG. 3 shows a portion of the flow reactor of FIG. 2 indicating flow paths for process gas. While adjacent plates have the same pattern of holes in terms of their location, which is required to allow the pipes to extend through the stack, adjacent plates have a different pattern in terms of which holes have an interference fit with the pipes and which holes have a clearance fit with the pipes. As such, process gas is forced in a circuitous path through a clearance fit around one pipe and then through a subsequent clearance fit around a different pipe.

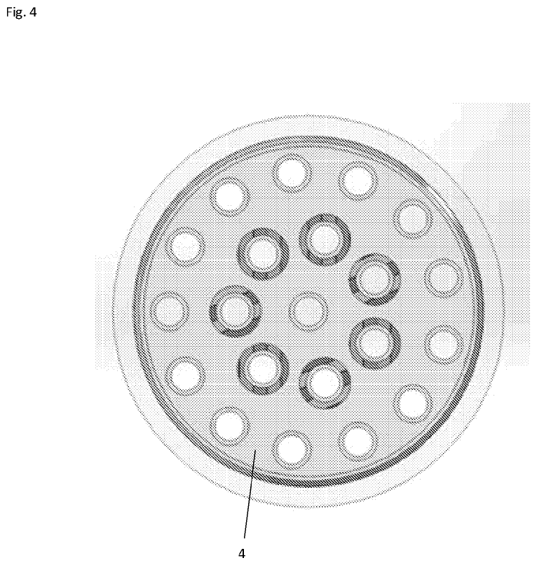

FIG. 4 shows the planar sealing plate 4 of FIG. 2 in a little more detail. As previously indicated, the sealing plates also comprise a hole configuration which is complimentary to the hole configurations in the corrugated plates to enable the pipes to extend through all of these plates and can include both interference fit holes and clearance fit holes. The sealing plates each comprising a peripheral seal which prevents fluid flow between the housing and the stacked plate assembly. These flat plates with seals prevent process gas from bypassing corrugated plates by flowing through a clearance between the reactor housing/shell and the corrugated plates. Furthermore, the flat plates facilitate the mixing of process fluid passing through various flow channels. For example, the flat sealing plates may have interference fit holes around a peripheral region and clearance fit holes in a more central region so as to force process gas back into a more central region of the reactor.

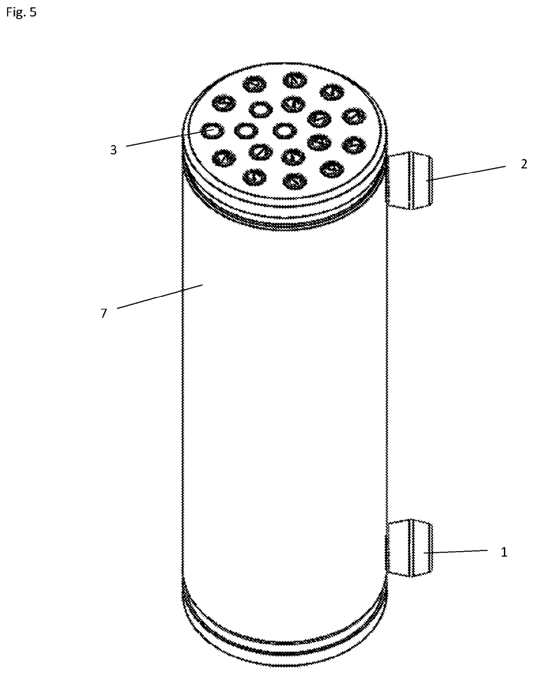

FIG. 5 shows an external view of another example of a flow reactor according to the present specification. The reactor includes an inlet 1, an outlet 2, a shell or housing 7, and a plurality of heat exchange pipes 3 extending through the shell/housing. The inlet and outlet are in fluid communication with the space withing the reactor housing/shell 7 around the heat exchange pipes 3.

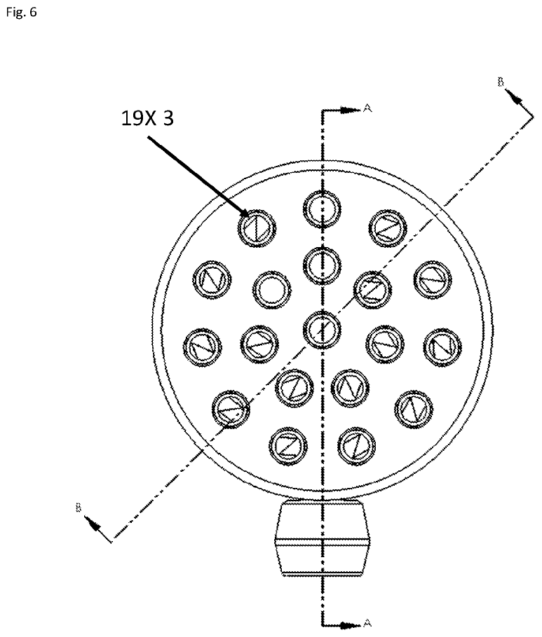

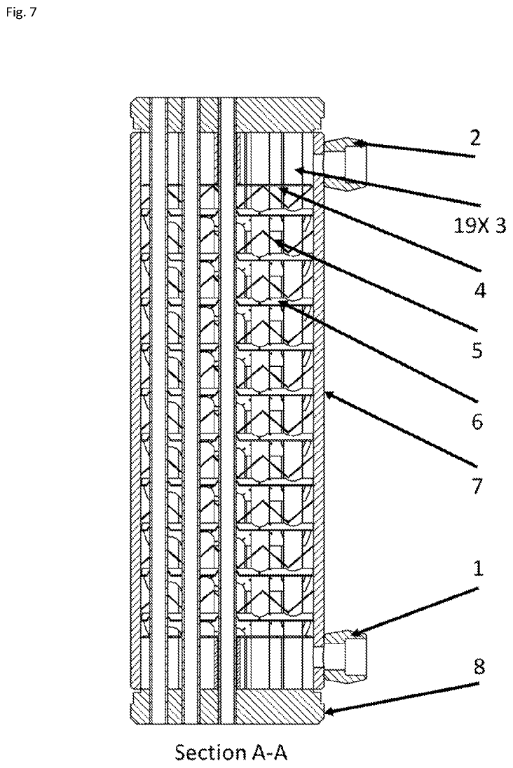

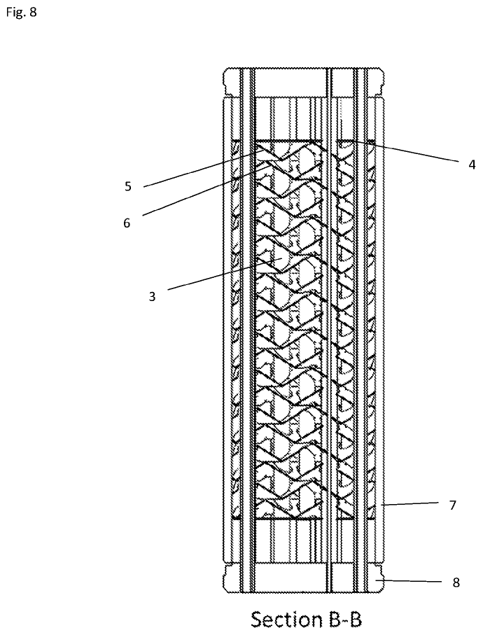

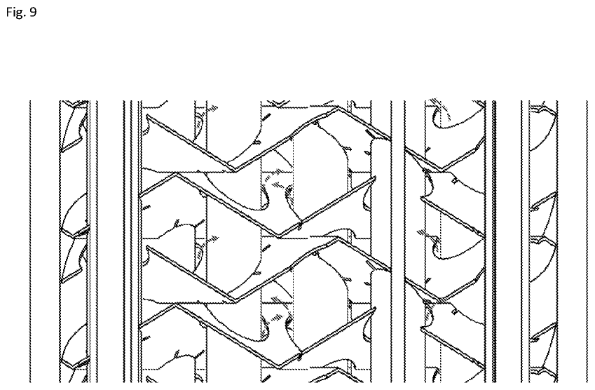

FIG. 6 shows a cross-sectional view of the flow reactor of FIG. 5. The flow reactor comprises nineteen heat exchange pipes 3. FIG. 6 also indicates a section A-A (shown in FIG. 7) and section B-B (shown in FIG. 8). As can be seen most clearly in FIG. 7, the reactor configuration comprises: an inlet port 1; an exhaust or outlet port 2; nineteen heating fluid pipes 3; flat plates 4 with sealing rings; a first type of corrugated plates 5; a second type of corrugated plates 6; a reactor shell or housing 7; and an end cap 8. As with previous examples, the two types of corrugated plate 5, 6 are inter-leaved and rest on each other with corrugations which are rotationally off set from each such that they do not nest together. As such, a plurality of flow channels is provided between the plates for process gas to contact catalyst or other active chemicals disposed or coated on the plates. Furthermore, the two types of corrugated plates, and also the planar sealing plates, have a plurality of holes which can be aligned to enable the heat exchange pipes to extend through the stack of plates. The plates have a different pattern of interference fit and clearance fit holes such that process gas is forced in a circuitous path through clearance fit holes around different heat exchange pipes as illustrated in FIG. 9 which shows a portion of the flow reactor of FIGS. 5 to 8 indicating flow paths for process gas.

While an important feature of the present specification is the provision of plate structures in the space between the pipes and the reactor housing/shell, in accordance with certain configurations structured elements can also be provide within one or more of the pipes to enhance heat transfer and/or to promote further reactions within the pipes if coated with a suitable active chemical. FIG. 6 shows an example of such structures within the pipes. In the illustrated example, so called “Z-strips” are provided in several of the pipes, which comprise structural elements having a Z-shaped cross-section that can be seen in the cross-sectional view of FIG. 6. These tube-side structural elements may be elongate and extend along the interior of the pipe(s)/tube(s). Optionally more than one such element may be provided in a pipe. Optionally, the structural elements within the pipes are made of a thermally conductive material (e.g. a metal/alloy). Preferably, the structural elements are non-planar, thus increasing their surface area and contact area with fluid flowing within the pipes. Such structural elements within the tubes are particularly useful for enhancing heat transfer within the pipes. The Z-strips (or corresponding structures) provide increased heat transfer by breaking the boundary layer of fluids/gasses. These can also be coated with active material for oxidation of exhaust gases and/or exothermic reaction for increased heat transfer. The internal pipe structures could also be static mixers or some configuration to cause turbidity to break up the boundary layer.

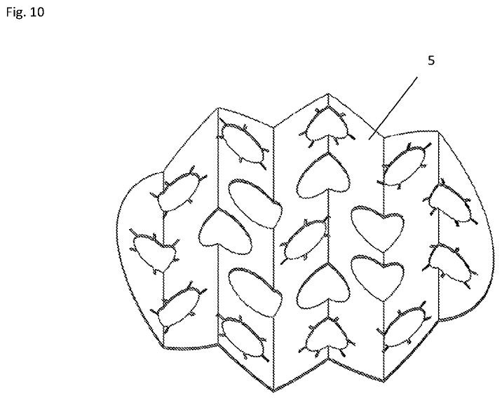

FIG. 10 shows one of the first type of corrugated plates 5 for use in the reactor of FIGS. 5 to 9. In this example, the plate comprises a central clearance fit hole and a peripheral ring of clearance fit holes. A ring of interference fit holes is provided between the central and peripheral clearance fit holes. The interference fit holes have a circular projected shape as viewed from above or below which is complimentary to the shape of the heat exchange pipes such that the holes form a close fit (interference fit) with the pipes to restrict process gas flow therethrough. The clearance fit holes also have a circular projected shape to fit around the heat exchange pipes. However, the clearance fit holes differ from the interference holes in that they each have a series of slots disposed around their circumference to enable process gas to readily flow therethrough. These slotted holes are one type of clearance hole. Other configurations can be envisaged. For example, the clearance holes may simply have a larger diameter than the heat exchange pipes to enable process gas flow through the plate. Alternatively, the clearance fit holes may have a non-circular or non-complimentary shape to the heat exchange pipes such that a gap or clearance is provided for process gas flow. Furthermore, while the plate is shown with a corrugation which has a triangular wave-form type structure comprising flat portions and edge portions, the corrugation may be curved or wave-like in construction having a more sinusoidal wave-form shape, or may alternative have a sawtooth or square wave-form shape. Alternatively still, the non-planar shape may be formed by a plurality of isolated indentations/projections rather than extended corrugations. They key functional feature of the non-planar structure is that when the plates are stack together they form an open structure with flow paths for process fluid/gas therebetween.

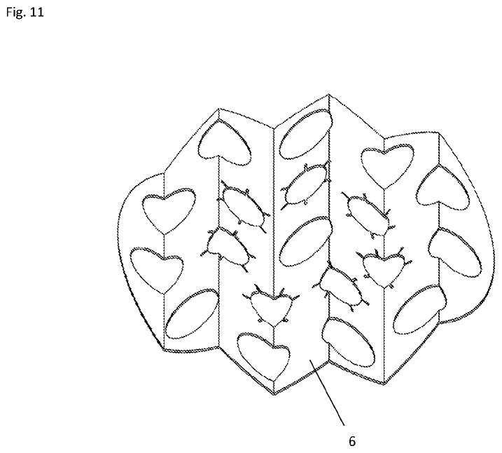

FIG. 11 shows one of the second type of corrugated plates 6 for use in the reactor of FIGS. 5 to 9. In this example, the plate comprises a central interference fit hole and a peripheral ring of interference fit holes. A ring of clearance fit holes is provided between the central and peripheral interference fit holes. That is, the pattern of interference and clearance fit holes is the opposite to that of the first type of plate shown in FIG. 10. It should also be noted that when the holes of the two plates shown in FIGS. 10 and 11 are aligned such that heat exchange pipes can extend through both types of plate, the corrugations of the two types of plates do not align. Rather, the corrugations are rotationally off set such that they do not nest together. This enables the two types of plates to be stacked in an alternating manner such that open flow paths are provided between the plates.

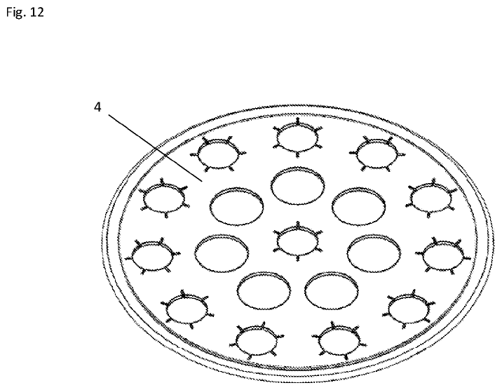

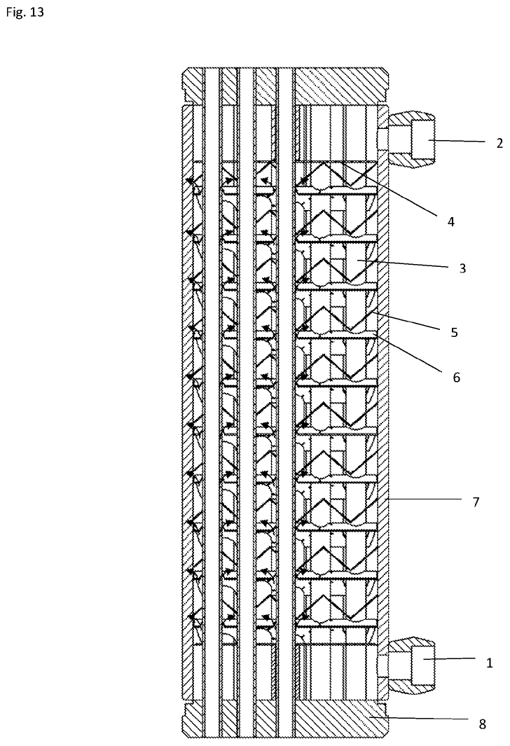

FIG. 12 shows a flat plate 4 with sealing ring for use in the reactor of FIGS. 5 to 9. In this example, the plate comprises a central clearance fit hole and a peripheral ring of clearance fit holes. A ring of interference fit holes is provided between the central and peripheral clearance fit holes. Such a planar plate with a peripheral sealing ring forms a more reliable interference fit with the outer wall compared to the corrugated plates and thus ensures that process gas doesn't by-pass the stacked plate configuration by flowing up the side walls of the reactor. Rather, the process gas is forced back into a more central region within the reactor to provided process fluid flow as illustrated in FIG. 13 which shows a cross-sectional view of the flow reactor of FIGS. 5 to 9 indicating flow paths for process gas.

The reactor configurations according to this specification thus provide a structured catalyst platform with enhanced heat transfer for shell-side reactor vessel applications. By shell-side it is meant that the catalyst is provided outside of the pipes in the space between the pipes and the shell or housing of the reactor, i.e., the catalyst is disposed on the shell-side of the pipes rather than within the interior of the pipes. In certain applications, the process gas on the shell-side of the vessel is heated via the tubes. In other applications, the reverse may be true and the process gas may transfer heat into the fluid within the tubes. The design of the shell and tube heat exchanger type catalytic reactor and its components have enhanced efficiency and ease of manufacturability.

Summarizing the preceding description of FIGS. 5 to 13, the apparatus is a shell and tube arrangement where the fluid flow in the shell-side and tube-side are separated. Multiple heat exchange tubes are provided through which the heating fluid flows. The process fluid flows through the shell-side. The corrugated plates are stacked as layers in the reactor shell consecutively and periodically. These plates have catalyst(s) or other chemicals coated thereon. The corrugated plates have holes that assemble onto and mate with the pipes that carry the heating fluid. The holes orient the coated plates in the assembly and thus preventing them from collapsing into adjacent layers. The hole sizes and types in the two corrugated plates are different. One set of holes is tight-fit (interference fit) with the pipes and restricts fluid flow through the plate-pipe interface. Another set of holes are clearance fit to the heating pipes (have a clearance between the heating pipes and the plate). Therefore, the process gas can flow through the plate-pipe interface with such a clearance fit joint. These alternating types of clearance and interference fits joints direct the process fluid in a circuitous path through channels in between corrugated plate layers.

Flat plates with a seal are periodically placed between corrugated plates stacks. These flat plates with seals prevent process gas from bypassing corrugated plates by flowing through the clearance between the reactor shell and the corrugated plates. Further, the flat plates facilitate the mixing of process fluid passing through various flow channels.

Thus, this design: a) periodically permits the process gas to conduct heat from the heating pipes as it flows past these pipes allowing the process gas to gain necessary thermal energy for chemical reaction before passing a section of the coated plate; and b) increases the contact area between coated plate surface and process gas. This enhanced contact results in increased chemical activity that improves process efficiency and throughput. The arrangement also provides greater heat transfer between the shell-side and tube-side of the reactor as well as creating lower pressure drops than if traditional pellets were used on the shell-side.

The active chemical on the plates can be one or more catalysts, one or more chemical reactants, or one or more adsorbents/absorbents. For example, the corrugated plates, and optionally the skirt seal plates, can be coated with catalyst according to a desired reaction. Alternating corrugated plates of each type are stacked one on top of another with corrugation directions that are rotated such that they do not nest upon one another (up to 90° but not 0°). Process fluid (e.g., gas) flows down (or up) through the plates and is directed radially due to alternating hole sizes/shapes in each plate. These holes, through which the tubes also pass, are either a close fit (so as to discourage flow past the tubes) or a wider fit (so as to encourage flow). This has the effect of directing flow in a zig-zag or circuitous path through the corrugations of each layer, impinging the flow upon the tubes for greater heat transfer. The corrugation geometry may be altered to maximise heat transfer. In the illustrated examples described previously, the cell geometry is straight. However, a herringbone corrugation geometry may also be used or some other pattern.

The corrugated plates can be stacked into sections that are separated by a skirt seal plate which serves to redirect flow generally from the edges of the vessel into the center of the vessel, ensuring mixing of any bypassed fluid that flows down the vessel walls. The sections may either be assembled layer by layer or pre-assembled as stacks in a coherent structure.

The configurations of this specification are also inherently scaleable. One current example comprises a reaction vessel of 4″ diameter with smaller internal heat exchange pipes extending therethrough. However, the reaction vessel could be larger and/or the geometry of the coated/corrugated plates (foils) can be altered to suit different applications. Process fluid flow may be down-flow or up-flow and therefore cocurrent with the heat exchange fluid within the tubes or countercurrent.

The configurations provide a shell-side structure of a shell/tube heat exchanger/reactor/reformer which directs flow such that impingement for greater heat transfer is experienced, pressure drop benefits of structured catalyst are realised, and skirt seals redirect flow and cause mixing. Benefits of the configurations include increased heat transfer, decreased pressure drop, and increased surface area compared to pellets. The specification provides a platform technology to replace pellets for reactors whose catalyst is on the shell-side rather than the tube-side. The shell-side reactor system may be provided either in a single tube-in-tube design or a multiple tube-in-tube design. Furthermore, gas that flows through the shell-side structured catalyst may be circulated around, after reaction, and flow back through the tubes to enable heat transfer between reactant and product gas. It is also envisaged that the reactor housing/shell may be (externally) heated, e.g., via electrical heating or rerouting exhaust gases acting as a heat exchanger.

Aspects of the specification include the reactor apparatus configurations, methods of operating the apparatus, and a set of coated plates for use in the reactor apparatus. While this invention has been particularly shown and described with reference to certain examples, it will be understood to those skilled in the art that various changes in form and detail may be made without departing from the scope of the invention as defined by the appended claims.

1. A chemical flow reactor comprising:
a housing having an inlet and an outlet;
at least one pipe extending through an interior of the housing;
a space defined between an interior surface of the housing and an outer surface of the at least one pipe, said space being in fluid communication with the inlet and the outlet;
a plurality of plates stacked within said space forming a stacked plate assembly between the inlet and the outlet, each plate comprising at least one hole through which the at least one pipe extends such that the at least one pipe extends through the stacked plate assembly with each plate extending between the outer surface of the at least one pipe and the inner surface of the housing and forming a plate-pipe interface region adjacent the outer surface of the at least one pipe and a plate-housing interface region adjacent the inner surface of the housing;
an active chemical disposed on at least a portion of at least one surface of each plate,
wherein at least some of the plates within the stacked plate assembly are non-planar, each non-planar plate comprising a series of grooves and ridges,
wherein adjacent plates within the stacked plate assembly are configured such that the grooves form fluid flow channels between the adjacent plates, and
wherein the plurality of plates within the stacked plate assembly comprise a first set of plates which form an interference fit with the at least one pipe restricting fluid flow through the plate-pipe interface region, and a second set of plates which form a clearance fit with the at least one pipe enabling fluid flow through the plate-pipe interface region, the first and second set of plates alternate within the stacked plate assembly thereby directing fluid in a circuitous path through the fluid flow channels between the plates from the inlet to the outlet.

2. The chemical flow reactor claim 1,
wherein the active chemical comprises at least one catalyst thereby forming a catalytic flow reactor.

3. The chemical flow reactor of claim 1,
wherein the active chemical is adhered to the plates.

4. The chemical flow reactor of claim 1,
wherein adjacent plates within the stacked plate assembly are in contact with each other and have a non-complimentary shape when configured in a stacked arrangement which ensures that flow channels between the adjacent plates are held open by the shape of the plates themselves, without the requirement for separate spacer structures.

5. The chemical flow reactor of claim 1,
wherein the non-planar plates within the stacked plate assembly are separate plate components which are not physically attached to each other.

6. The chemical flow reactor of claim 1,
wherein at least a number of the non-planar plates within the stacked plate assembly are physically attached to each other.

7. The chemical flow reactor of claim 1,
wherein the first set of plates are orientated such that their grooves extend in a first direction and the second set of plates are orientated such that their grooves extend in a second direction which is rotationally off set from the first direction.

8. The chemical flow reactor of claim 1,
wherein the plates are corrugated with linear or non-linear channels.

9. The chemical flow reactor of claim 1,
wherein the first set of plates form a clearance fit with the housing enabling fluid flow through the plate-housing interface region, and the second set of plates form an interference fit with the housing restricting fluid flow through the plate-housing interface region,
whereby the circuitous path for fluid flow is, at least in part, between the clearance fit at the plate-housing interface region of the first set of plates and the clearance fit at the plate-pipe interface region of the second set of plates.

10. The chemical flow reactor of claim 1,
wherein more than one pipe extends through the stacked plate assembly, each plate comprising a plurality of holes, one hole for each pipe.

11. The chemical flow reactor of claim 1,
wherein each plate of the first and second sets of plates comprises at least one clearance fit hole and at least one interference fit hole, and
in the stacked plate assembly, the at least one clearance fit hole of the first set of plates is around a different pipe to the at least one clearance fit hole of the of the second set of plates, and the at least one interference fit hole of the first set of plates is around a different pipe to the at least one interference fit hole of the second set of plates,
whereby the circuitous path for fluid flow is, at least one part, between the clearance fit at the plate-pipe interface region of the first set of plates around one pipe and the clearance fit at the plate-pipe interface region of the second set of plates around a different pipe.

12. The chemical flow reactor of claim 1,
wherein each plate of the first and second sets of plates comprises a plurality of clearance fit holes and a plurality of interference fit holes, and
in the stacked plate assembly, the clearance fit holes of the first set of plates are around different pipes to the clearance fit holes of the second set of plates, and the interference fit holes of the first set of plates are around different pipes to the interference fit holes of the second set of plates,
whereby a plurality of circuitous paths for fluid flow are provided between the different pipes.

13. The chemical flow reactor of claim 1,
wherein the stacked plate assembly comprises a series of sealing plates which are periodically placed between the non-planar plates, the sealing plates each comprising a peripheral seal which prevents fluid flow between the housing and the stacked plate assembly.

14. The chemical flow reactor of claim 1,
wherein the sealing plates are planar.

15. The chemical flow reactor of claim 1,
wherein the stacked plate assembly comprises more than two sets of non-planar plates which differ in terms of their non-planar shape, rotational orientation, and/or fit with the at least one pipe or housing.

16. A method of operating the chemical flow reactor of claim 1,
wherein process fluid is flowed from the inlet to the outlet through the stacked plate assembly, the process fluid reacting with the active chemical on the plates or reacting due to a catalytic action of the active chemical on the plates,
wherein heat exchange fluid is flowed through the one or more pipes,
whereby heat is exchanged between the process fluid and the heat exchange fluid at the walls of the one or more pipes.

17. The method of claim 16,
wherein the process fluid flow and the heat exchange fluid flow are in a co-current or counter current direction.

18. The method of claim 16,
wherein the heat exchange fluid is at a higher temperature than the process fluid and thermal energy is transferred from the heat exchange fluid to the process fluid, or vice versa.

19. The method of claim 16,
wherein the process fluid is circulated from the outlet back though at least one of the pipes, whereby the process fluid functions, at least in part, as the heat exchange fluid enabling heat transfer between reactant process fluid and product process fluid.

20. (canceled)

21. (canceled)

22. (canceled)

23. (canceled)

24. (canceled)

25. (canceled)

26. (canceled)

27. (canceled)

28. (canceled)

29. (canceled)

30. (canceled)
